(19) United States
(12) Patent Application Publication
(10) Pub. No.: US 2008/0219487 A1
(43) Pub. Date: Sep. 11, 2008

(54) Voltage source with a coated housing

(75) Inventors: Anton Gebert, Kleinsendelbach (DE); Kunibert Husung, Erlangen (DE)

Correspondence Address: SIEMENS CORPORATION;INTELLECTUAL PROPERTY DEPARTMENT, 170 WOOD AVENUE SOUTH, ISELIN, NJ, 08830, US

(73) Assignee: SIEMENS AUDIOLOGISCHE TECHNIK GMBH

(21) Appl. No.: 12/074,437

(22) Filed: Mar. 4, 2008

(30) Foreign Application Priority Data
Mar. 5, 2007 (DE) 10 2007 010 602.7

(51) Int. Cl. H04R 25/00; H01M 2/02

(52) U.S. Cl. 381/323; 429/163

(57) ABSTRACT

In the case of a voltage source with a housing for supplying power to a medical device which can be worn on or in the human body, the failure rate determined by external environment influences or contamination is to be reduced. To this end, provision is made for the exterior of the housing of the voltage source to be provided with a hydrophobic and/or oleophobic and/or biofilm-inhibiting coating. The moisture and contamination-repellent coating largely protects the voltage source from external environmental influences and contamination. Failures determined by external environmental influences or contamination are herewith largely avoided.

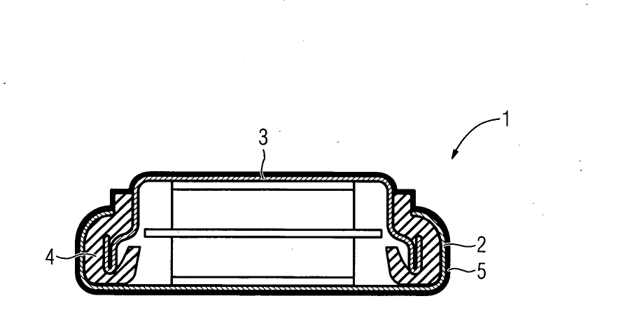

### CROSS REFERENCE TO RELATED APPLICATIONS

This application claims priority of German application No. 10 2007 010 602.7 DE filed Mar. 5, 2007, which is incorporated by reference herein in its entirety.

### FIELD OF INVENTION

The invention relates to a voltage source with a housing for supplying power to a medical device which can be worn on or in the human body.

### BACKGROUND OF INVENTION

Voltage sources in the form of batteries or rechargeable accumulators are generally used to operate medical devices which can be worn on or in the human body, such as hearing aid devices, heart pacemakers, devices for administering drugs or diagnostic recording devices for instance.

A complete casing of the voltage source used in the medical device is generally not possible since a gas exchange is sometimes required in order to operate the used voltage sources, and also has to be possible by the user when the voltage source is empty or consumed. The used voltage sources are thus exposed to extreme external influences in the case of a medical device which is worn on or in the body. Moisture, fat or alcohols (during cleaning) particularly affect the voltage sources. In the case of their use in hearing aid devices, the voltage sources are above all exposed to gaseous, liquid or solid cerumen parts, however moisture and sweat can also affect the surface of a relevant voltage source.

One particular problem arises with the use of rechargeable batteries (accumulators), which, in particular, remain in the relevant medical device during the charging process and are thus not replaced over a longer period of time, for instance over several years. They are herewith exposed to extreme amounts of dirt. This frequently results in damage to and sometimes even in complete failure of the used voltage source.

The publication US 2006/0093917 A1 discloses the use of a rechargeable lithium ion battery for use in a medical device which can be worn in or on the body of a user.

The publication DE 102 19 679 A1 also describes a hearing device or hearing device parts for insertion into the auditory canal and/or the concha of a wearer. The hearing device or the hearing device part is provided with a biofilm-inhibiting coating. The formation of a coating of cerumen on the hearing device and/or hearing device part is thus to be prevented.

### SUMMARY OF INVENTION

The object of the present invention is to prevent failure of the voltages source used in a medical device as a result of external environmental influences.

In accordance with the invention, this object is achieved by a voltage source with a housing for supplying power to a medical device which can be worn on or in the human body, with the exterior of the housing of the voltage source comprising a hydrophobic and/or oleophobic and/or biofilm-inhibiting coating.

Advantageously, in the case of a voltage source according to the invention, scarcely any dirt accumulates on the exterior of the housing of the relevant voltage source. Furthermore, the coating prevents the dirt from sticking, so that dirt particles which reach the surface of the voltage source often fall off the surface by themselves again as a result of the movement of the medical device. Furthermore, a simple cleaning of the relevant voltage source is possible, for instance by blowing the medical device or by removing the voltage source from the device and subsequently wiping it clean. In particular, the coating prevents the housing surface of the voltage source from being attacked and damaged by contaminations and moisture, this otherwise also potentially resulting in problems with the electrical contacting of the relevant voltage source.

The invention enables the service life of the medical devices which can be worn in or on the human body to be significantly lengthened. The use of a biofilm-inhibiting, in particular bactericidal or fungicidal coating prevents pathogens from increasing on the surface of the voltage source, which could even result in the health of the user being endangered.

The coating is preferably manufactured using chemical nanotechnology and comprises hydrophobic or oleophobic characteristics. This is advantageous in that the external dimensions of the voltage source are not significantly changed by the coating. The coating on the contact points for electrically contacting a relevant voltage source can also be easily removed, for instance by mechanically scraping off the coating in the region of the relevant contact points.

Biofilm-inhibiting, in particular antibacterial characteristics of the coating can be achieved in particular by incorporating silver ions into the coating.

At the end of the manufacturing process, the voltage source is preferably completely covered with a coating. Contact surfaces for electrically contacting the voltage source are then, if necessary, subsequently freed from this coating.

It is also possible for relatively small subareas of the housing of the voltage source not to be covered with a coating, with the regions that remain free being used to electrically contact the voltage source.

It is also possible for different regions of the voltage source to be covered with different coatings, which have in particular different electrical characteristics. An electrically conductive coating can thus be used for subareas of the surface of the voltage source, which are used for electrical contacting. The remaining housing regions are however provided with an electrically insulating coating.

With a further embodiment of the invention, only the subareas of the housing of the voltage source consisting of metal are covered with the coating and the insulator between these metal regions, which only takes up a very small part of the housing surface, has no corresponding coating. This can herewith be achieved for instance in that the used coating does not stick to the insulator material. With this embodiment, the coating can be embodied in an electrically conductive fashion and a partial removal of the coating for electrically contacting the voltage source is unnecessary.

With another embodiment of the invention, the material characteristics, and in particular the durability of the coating are selected such that contacts of the medical device which are embodied with relatively pointed ends penetrate the insulating coating of the voltage source and herewith produce the electrical contacts.

### BRIEF DESCRIPTION OF THE DRAWINGS

The invention is described below with reference to an exemplary embodiment. The figure shows a voltage source 1 embodied as a battery or rechargeable accumulator.

### DETAILED DESCRIPTION OF INVENTION

The housing of the voltage source 1 is essentially made up of three subareas. These are the positive pole 2 consisting of a metal or metal alloy, the negative pole 3 likewise consisting of a metal or metal alloy and the insulator 4 separating the positive pole 2 from the negative pole 3.

In the exemplary embodiment, the exterior of the voltage source 1 is completely provided with a hydrophobic, oleophobic and antibacterial active coating 5, which is advantageously manufactured according to known methods of chemical nanotechnology. The voltage source 1 is therewith largely protected against moisture and contamination.

So that the coating does not cause the voltage source 1 to self-discharge, the coating is embodied as an electrical insulator, in other words, is not conductive. In order to contact the voltage source in a medical device, the coating in the region of the contact points for electrically contacting the medical device has to be removed. Alternatively, the contacts on the medical device are also embodied with pointed or sharp edges such that the contact ends penetrate the coating 5 for contacting purposes.

The coating protects the voltage source 1, even with a longer residence time in the medical device, against external environmental influences, in particular moisture or contamination. In the case of accumulators that can be recharged within the respective medical device, and have to be exchanged relatively infrequently, the failure rates can herewith be significantly reduced.

In addition to hydrophobic and oleophobic characteristics, the coating 2 advantageously also comprises biofilm-inhibiting characteristics, as a result of which the increase in bacteria on the surface of the voltage source 1 is prevented.

1.-9. (canceled)

10. A voltage source with for supplying power to a medical device which can be worn on or in the human body, comprising:
a housing having an exterior portion, the exterior portion of the housing comprises a coating, the coating selected from the group consisting of hydrophobic, oleophobic and biofilm-inhibiting.

11. The voltage source as claimed in claim 10, wherein the coating is manufactured using chemical nanotechnology.

12. The voltage source as claimed in claim 10, wherein the exterior portion of the housing is completely covered with the coating.

13. The voltage source as claimed in claim 10, wherein the coating is removed from a contact surface area of the exterior portion of the housing.

14. The voltage source as claimed in claim 10,
wherein the exterior portion of the housing includes a subarea, and
wherein the subarea is provided with different coating.

15. The voltage source as claimed in claim 13, wherein the different coatings comprise different electrical characteristics.

16. The voltage source as claimed in claim 10, wherein silver ions are incorporated into the coating.

17. The voltage source as claimed in claim 10, wherein the voltage source is embodied as a battery.

18. The voltage source as claimed in claim 10, wherein the voltage source is embodied as a rechargeable accumulator.

19. The voltage source as claimed in claim 10, wherein the voltage source is included in a hearing aid device.

20. A hearing aid device, comprising:
a voltage source with for supplying power to the hearing device, the voltage source comprising:
a housing having an exterior portion, the exterior portion of the housing comprises a coating manufactured using chemical nanotechnology, the coating selected from the group consisting of hydrophobic, oleophobic and biofilm-inhibiting.
